(19) United States
(12) Patent Application Publication
(10) Pub. No.: US 2008/0153069 A1
(43) Pub. Date: Jun. 26, 2008

(54) METHOD, MACHINE-READABLE MEDIUM AND COMPUTER CONCERNING THE MANUFACTURE OF DENTAL PROSTHESES

(76) Inventors: Stephan HOLZNER, Hohenschaftlarn (DE); Gerhard Weber, Purgen (DE)

Correspondence Address: FLEIT KAIN GIBBONS GUTMAN BONGINI & BIANCO, 21355 EAST DIXIE HIGHWAY, SUITE 115, MIAMI, FL, 33180, US

(21) Appl. No.: 11/955,058

(22) Filed: Dec. 12, 2007

(30) Foreign Application Priority Data
Dec. 22, 2006 (DE) 10 2006 061143.8

(51) Int. Cl. A61C 5/10

(52) U.S. Cl. 433/223

(57) ABSTRACT

The invention relates to a method by which a mold for casting, such as metal casting, of dental prostheses is prepared, with the step of: preparing the mold on the basis of mold model data with a CAM/CAD method. Furthermore, the invention relates to a method for the determination of a shape of a mold for casting, such as metal casting, of dental prostheses with the step of: creating mold model data describing the shape of the mold.

### CROSS REFERENCE TO RELATED APPLICATION

This application claims priority under 35 U.S.C. §119 to German Patent Application No. 10 2006 061143.8 filed Dec. 22, 2006, the entire contents of which are incorporated herein by reference.

### FIELD OF THE INVENTION

The use of CAM/CAD methods in the manufacture of dental prostheses is well-known. Here, the CAM/CAD methods are employed for milling a dental prosthesis, for example from a blank. This dental prosthesis then has an individual shape.

### BACKGROUND OF THE INVENTION

It is also well-known, for example, to employ laser sintering for manufacturing dental prostheses individually. Here, for example gold powder is locally melted to thus manufacture a dental prosthesis directly from gold.

The latter method requires relatively large amounts of gold for the corresponding laser methods and therefore is rather costly.

### SUMMARY OF THE INVENTION

It is the object of the present invention to provide a possibility by which individually shaped dental prostheses of metal or other castable materials can be manufactured possibly easily and inexpensively.

This object is achieved by a method according to claim 1, 12 or 14 as well as with a medium according to claim 18, and a computer according to claim 19. Preferred embodiments are disclosed in the dependent claims.

In the method, a mold for casting or metal casting is prepared with a CAM (computer-aided manufacturing) method, wherein in the method mold model data describing the shape of the mold are used. Preferably, these are created in advance, possibly, however, at another location or by other enterprises or persons.

The mold can be prepared with a CAM method from a comparably inexpensive material (compared to gold) and subsequently be used, for example, for casting dental prostheses of gold with these. Here then only (relatively low) amounts of gold are used as they are required for the dental prosthesis itself.

One example of the CAM method is laser sintering, 3D laser lithography, milling or another rapid prototyping method (for example stereolithography, laser generating, fused deposition modeling, laminated object modeling, 3D printing, contour crafting, multijet modeling, polyjet method or other ones). In general, rapid prototyping methods are primary shaping methods building a work piece in layers of shapeless or shape-neutral materials with the utilization of physical and/or chemical effects.

In the method, CAD (computer-aided design) methods and/or means can also be employed.

In a preferred variant of an embodiment, during the creation of mold model data, a model of a dental prosthesis is created in advance. On the basis of such a model of a dental prosthesis with the desired shape, then, for example, the mold model data can be directly acquired.

For creating the mold model data, for example, a model of a dental prosthesis can be scanned. In the process, the shape of the desired dental prosthesis can be very precisely acquired, and thus very precise mold model data can be created.

The dental prosthesis can be or be comprised of, for example, a small cap, a bridge, a portion of an implant, a portion of an inlay, or any other dental prosthesis.

The mold is preferably a one-piece mold. Thereby, the mold can be easily handled, and the one-piece mold facilitates the casting operation.

However, the mold can also be a two-, three-, four-piece mold or a mold with even more pieces. The advantage is that even CAM methods with which it is difficult to prepare cavities or hollow spaces, respectively (for example milling), can be employed.

A mold prepared with the CAM method can subsequently be provided with a pouring sprue. This can be made manually or in an automated manner.

It is also possible that the mold model data already provide a pouring sprue, so that it is already prepared along when the CAM method is carried out.

As materials for the mold, in particular those materials are considered which can resist high temperatures as they occur in casting, in particular in metal casting. These in particular include metals, ceramics, glass, gypsum, semiconductors, such as silicon, or similar materials. Even (extremely) temperature-resistant plastics could be employed here. The material has to resist at least the temperature the molten cast material, such as the metal, has.

The mold should resist temperatures of up to e.g. 100° C., 200° C., 300° C., 400° C., 500° C., 600° C., 700° C., 800° C., 900° C., 1000° C., 1065° C. or 1100° C.

In a method for the manufacture of a dental prosthesis, first a mold for casting or metal casting, respectively, is prepared, and subsequently the dental prosthesis is obtained e.g. from metal by casting with the mold. The metal is in particular gold or a gold alloy, respectively, which is suited, for example, for dental prostheses. Plastics that can be cast (e.g. in an injection molding method) or curing plastics that can be poured into the mold in a liquid state and cure in the mold, can also be employed.

The invention furthermore relates to a method for the determination of the shape of a mold for casting, such as metal casting, of dental prostheses with the step of creating mold model data describing the shape of the mold. These mold model data can be created on the basis of previously created dental prosthesis model data.

From the model data describing the dental prosthesis, the data record describing the shape of the mold can be automatically created.

The data acquired in this manner can be, for example, sent to a manufacturing center which then prepares a mold from the data. This transmission can be performed, for example, with remote data transmission (and corresponding remote data transmission means). Data giving the shape of the desired dental prosthesis can also be transmitted via remote data transmission and thus the data record for the mold can be created at another location.

The dental prosthesis model data can be or comprise, for example, surface data giving the surface of the desired dental prosthesis model. These surface data can be taken over or used, respectively, for preparing surfaces of the mold model data.

Preferably, data for a pouring sprue are furthermore added automatically or manually.

The invention furthermore relates to a machine-readable medium with instructions that can be carried out by a computer when they are read-in by the computer, so that the computer carries out a method as it is described above or below.

Furthermore, the invention relates to a computer with a machine-readable medium as it is described above or below. The machine-readable medium can be, for example, a CD, a DVD or a hard disk or another storage or storage medium.

### BRIEF DESCRIPTION OF THE DRAWINGS

Preferred embodiments of the invention will be illustrated with reference to the enclosed figures. In the drawings:

FIG. 1 shows a mold for casting dental prostheses;

FIG. 2 shows a section of the mold of FIG. 1;

FIG. 3 shows a dental prosthesis;

FIG. 4 shows a schematic representation of the devices for carrying out a method for manufacturing a mold;

FIG. 5 shows a two-piece mold;

FIG. 6 shows a schematic representation of surface data.

### DETAILED DESCRIPTION OF THE INVENTION

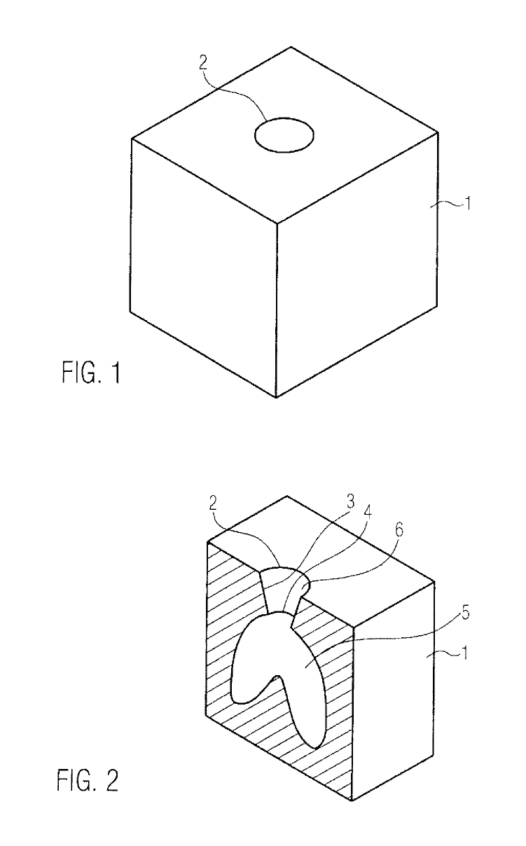

FIG. 1 shows a mold 1 for (metal) casting of dental prostheses. In FIG. 1, the mold is shown from outside, where only the upper end 2 of a pouring sprue can be seen. While the mold 1 in FIG. 1 has a rectangular shape, it can also comprise any other suited external shape, such as, for example, spherical, circular cylindrical or the like. Projections or indentations by which the mold 1 can be e.g. held or clearly identified in its position can also be provided in the outer surface. For the latter purpose, markings, (bar) codes or the like can also be provided.

In FIG. 2, a section of the mold of FIG. 1 is shown. The section extends through the pouring sprue 6. In the sectional view in FIG. 2, a cavity 5 can be seen which has the shape of a desired dental prosthesis.

The pouring sprue 6 leads to the cavity 5, the sprue starting at the upper end 2 positioned at the outer surface of the mold 1 and ending at the lower end 4, this lower end ending in the cavity 5. Between the upper end 2 and the lower end 4, the pouring sprue has a narrowing design, so that pouring in cast material into the larger upper opening 2 is easily possible, however, the area of the cavity 5 into which the pouring sprue 6 ends, and in which the desired shape is thus not achieved, is as small as possible.

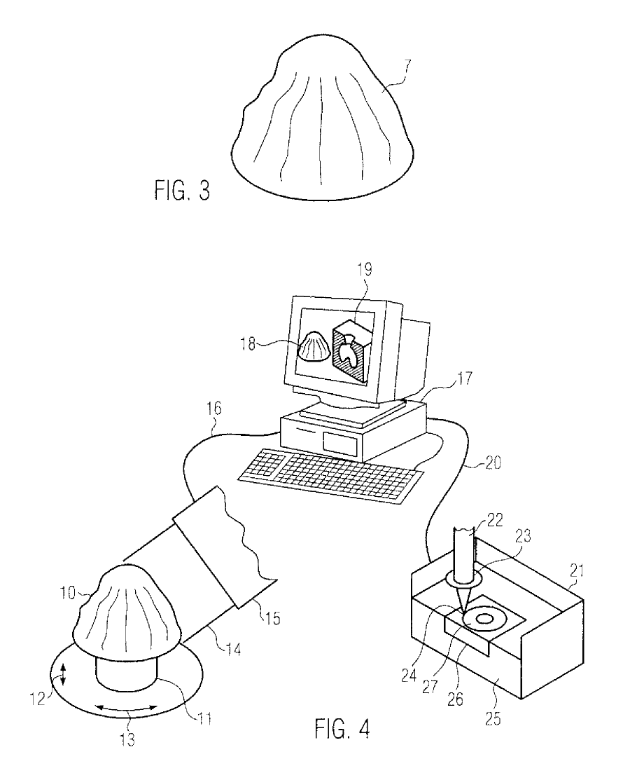

In FIG. 3, a dental prosthesis 7 as it can be obtained from the cavity 5 of FIG. 2 is shown. The cavity 5 as well as correspondingly the dental prosthesis 7 have an irregular shape and are shaped each individually in dental prostheses, i.e. each dental prosthesis differs from other dental prostheses, and from each mold 1 always only one single dental prosthesis 7 is obtained. To reach the thus prepared dental prosthesis 7 after the filling of the cavity 5 with the cast material, the mold 1 has to be destroyed.

A possible cast remainder present in the pouring sprue 6 has to be correspondingly removed to finish the dental prosthesis 7, as it is shown in FIG. 3.

In FIG. 4, a device with which the various methods or various procedure steps can be carried out is schematically shown.

A model of a dental prosthesis 10 is modeled on a rotating support 11. It can have been modeled on, for example, with wax, knead or other dough. The support 11 is mounted so as to be rotatable in the direction of arrow 13 and/or can be shifted in the direction of arrow 12. By rotating or shifting the model 10, it can be scanned with a scanning device 15 with respect to its shape. In FIG. 4, by way of example an optical probe 15 is shown which scans the outer shape of the model 10 by means of a light beam 14. Instead of the rotation 13 or the shifting 12, the optical probe 15 can also be moved relative to the model 10, wherein the model 10 stands still or is merely rotated.

The data acquired from the optical probe 15 are read into a computer 17 via a data connection 16. Then, a data record 18 which describes the outer shape of the model 10 is present oil the computer 17.

The inner shape of the model 10 can be concluded, for example, from a known shape of the support 11, or the inner shape can be determined in another scanning operation.

Alternatively, it is also possible to scan a model of a remaining tooth area or to scan a remaining tooth area itself with an optical probe 15 and to store the model data thereof on the computer 17. With modeling software, it is then possible to create and visualize a dental prosthesis model data record 18 on the digitally acquired remaining tooth area.

Independent of how the dental prosthesis model data record 18 has been acquired, with the computer 17 or else with another computer than that connected to the optical probe 15, now the mold model data 19 of a mold can be created.

This will be discussed more in detail below in the description of FIG. 6.

The computer 17 or else another computer can control a manufacturing means 21 for manufacturing the mold 1. To this end, the mold model data 19 are transmitted by means of data transmission, for example remote data transmission, to a CAM system, such as a rapid prototyping system.

In FIG. 4, a laser sintering system is schematically shown, wherein a laser beam 22 is focused with optics 23 to a focus area 24, wherein a material hardens in the focus area 24 by the action of the laser beam. Here, for example powder can be molten which solidifies after cooling down. Moreover, another chemical reaction can be induced which results in a solidification of a material. In FIG. 4, the already solidified material is designated with reference numeral 26. The non-solidified material is represented with reference numeral 25. In a rapid prototyping method, it is common to cover the already manufactured part 26 with a thin material layer 25 and to then harden it again with the laser focus 24 at the desired points. To this end, the part 26 can be gradually moved downwards, or a new, powdery or liquid material layer 25 can be applied onto the already prepared part 26.

In FIG. 4, one can see that a portion of a hollow space 27 has been already created which corresponds to the lower area of the cavity 5 in FIG. 2.

The representation of the device 21 in FIG. 4 is shown in a sectional drawing to thus better illustrate the method. With the device 21 or FIG. 4, a finished mold, as it is represented in FIGS. 1 and 2, can be prepared. With this mold, subsequently a dental prosthesis can be manufactured by means of (metal) casting. This dental prosthesis then has the shape of the model 10 of FIG. 4.

The acquisition of the dental prosthesis model data 18 and/or the creation of the mold model data 19 from the dental prosthesis model data 18 and/or the manufacture of the mold 1 can be each performed at the same or at various locations. Thus it is, for example, possible to perform the scanning in a dentistry laboratory, to perform the calculation of the mold model data 19 in a central computer center, and to perform the manufacture of the mold 1 in a manufacturing center affiliated to the computer center or being provided separately.

The obtained mold 1 can, for example, be dispatched to a dentistry laboratory, or else the (metal) casting can be already performed in a manufacturing center for dental prostheses, and the finished dental prosthesis can be dispatched to the dentistry laboratory.

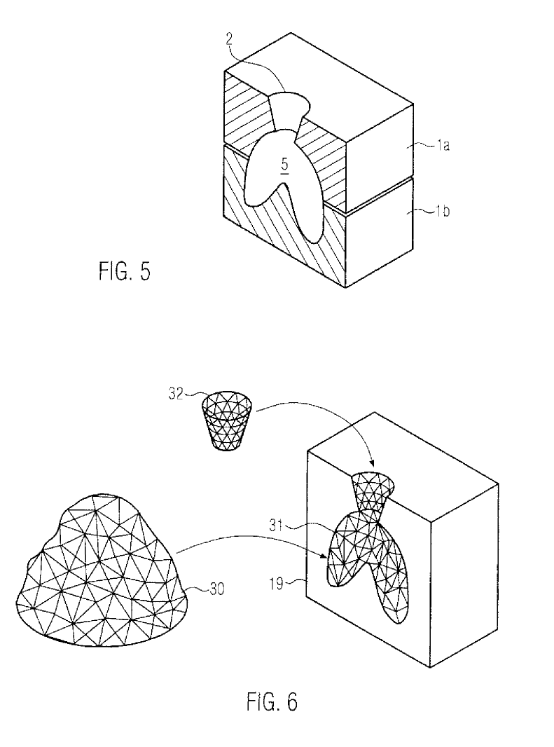

In FIG. 5, a special case of a mold 1 which is composed of several parts 1a, 1b is shown. Instead of only two parts 1a, 1b, even more parts can be provided. By the division of the mold 1 into several mold parts 1a, 1b, it is possible to provide model parts 1a, 1b which do not comprise any hollow spaces and possibly even do not comprise any undercuts, so that these can also be made with processing methods with which it is not or only hardly possible to create hollow spaces. For example, milling methods with milling heads can thus be employed to separately prepare the mold parts 1a, 1b without undercuts or nearly without undercuts, and to join the same subsequently, so that the desired cavity 5 is formed.

The two mold parts 1a, 1b can be interconnected or only be pressed on one another by corresponding mountings.

At the point where the two mold parts 1a, 1b contact each other, a flash can be possibly formed which has to be removed subsequently.

A two-piece mold (or a mold with more pieces) also facilitates the withdrawal of the dental prosthesis from the mold. In two- or multi-piece molds, the mold does not have to be destroyed in all cases.

In FIG. 6, a possible method with which the mold model data are prepared from dental prosthesis model data is schematically shown. Mold model data can be given, for example, by a three-dimensional grid 30 reproducing the surface of the desired dental prosthesis. The representation in FIG. 6 is relatively rough for clarity reasons; in practical methods, the data 30 will be composed of several ten or hundred thousands or even of several million surface elements, these being, as a rule, for example triangular. The surface data 30 can be used for modeling the desired cavity 5 in the model data 19. The cavity 5 can, for example, be modeled with surface data 31 which exactly correspond to those of the dental prosthesis surface model data 30, or they can be derived from the same. Thus, it would be conceivable, for example, that the surface data 31 reproduce a slightly larger or slightly smaller surface than that of the surface data 30 of the desired dental prosthesis to compensate production tolerances or to compensate shrinking occurring in the production of the dental prosthesis by the mold or by the (metal) casting. Shrinking occurs e.g. in the firing of ceramic molds.

Apart from the cavity 5, the pouring sprue 6 also has to be modeled. To this end, surface data 32 compiled beforehand and representing the surface of a pouring sprue with a grid can be integrated in the model data record 19. Instead of a grid, other data reproducing the surface of a small tube or a truncated cone or the like can be used. The surface data 32 and the surface data 31 will intersect in a certain area, so that the pouring sprue 6 ends in the cavity 5 at the end.

The location and/or the shape of the pouring sprue 6 represented by the data 32 can be automatically determined or else be changed or determined manually. To this end, corresponding data can be entered manually in a computer. For the automatic positioning and dimensioning of the pouring sprue 6, the surface data 31 as well as the data representing the outer boundary of the mold 1 can be taken into consideration. It is thus, for example, possible that the upper end 2 of the pouring sprue 6 is always situated at a predetermined location in comparison to the outer shape (see FIG. 1) of the mold 1. This facilitates automated (metal) casting as the location where the liquid cast material (metal) has to be introduced into the mold 1 is known beforehand.

The methods described herein are advantageously carried out by one or several computers. The instructions for carrying out the methods can be advantageously stored on a machine-readable medium.

1. Method by which a mold (1) for casting, such as metal casting, of dental prostheses (7) is prepared,
with the step of:
preparing the mold (1) on the basis of mold model data (19) with a CAM method.

2. Method according to claim 1, characterized by the preceding step of:
creating mold model data (19) describing the shape of the mold (1).

3. Method according to claim 1, characterized in that the CAM method comprises one or several of the following methods: laser sintering, laser lithography, milling, a rapid prototyping method.

4. Method according to claim 1, characterized in that the creation of mold model data (19) comprises the preceding creation of a model (10) of a dental prosthesis (7).

5. Method according to claim 1, characterized in that the creation of mold model data (19) comprises the preceding creation of dental prosthesis model data (18).

6. Method according to claim 1, characterized in that the creation of mold model data (19) comprises the scanning of a model (10) of a dental prosthesis (7).

7. Method according to claim 1, characterized in that the dental prosthesis (7) is or is composed of a small cap, a bridge, a portion of an implant or a portion of an inlay.

8. Method according to claim 1, characterized in that the mold (1, 1a, 1b) is a one-piece, two-piece or three-piece mold, or a mold with more pieces.

9. Method according to claim 1, characterized in that a pouring sprue (6) is prepared in the finished mold.

10. Method according to claim 1, characterized in that a pouring sprue (6) is provided in the mold model data (19) and finished along in the CAM method.

11. Method according to claim 1, characterized in that the mold (1) comprises one or several of the materials below of the following group of materials or consists of one or several materials of the following group: metal, ceramics, plastics, glass, gypsum, semiconductor, silicon.

12. Method for manufacturing a dental prosthesis with the steps of:
preparing a mold for casting, such as metal casting, with a method according to claim 1, and
casting the dental prosthesis of metal or another castable material in the mold.

13. Method according to claim 12, characterized in that the metal is gold or a gold alloy.

14. Method for the determination of a shape of a mold for casting, such as metal casting, of dental prostheses with the step of:
creating mold model data (19) describing the shape of the mold (1).

15. Method according to claim 14, characterized by the steps of:
creating dental prosthesis model data (18), and
creating the mold model data (19) on the basis of the dental prosthesis model data (18).

16. Method according to claim 14, characterized in that the mold model data are created by using and/or taking over surface data (30) of the dental prosthesis model data (18).

17. Method according to claim 14, characterized in that a location for a pouring sprue is automatically determined in the model data (19) or entered manually, and preferably surface data (32) modeling the pouring sprue (6) are added to the mold model data from previously stored or manually entered data.

18. Machine-readable medium with instructions that can be carried out by a computer when they are read-in by the computer, so that the computer carries out a method according to claim 1.

19. Computer with a machine-readable medium according to claim 18.
